(19) United States
(12) Patent Application Publication
(10) Pub. No.: US 2024/0100569 A1
(43) Pub. Date: Mar. 28, 2024

(54) Method and Apparatus for Recovering Down from Padded Products

(71) Applicant: Moncler S.P.A., Milano (IT)

(72) Inventors: Karsten Stienemann, Gronau (DE); Jan Stienemann, Gronau (DE); Kotaro Tatsuma, Krakow (PL); Fabrizio Ruffini, Cernobbio (IT)

(21) Appl. No.: 18/531,401

(22) Filed: Dec. 6, 2023

(30) Foreign Application Priority Data
Mar. 15, 2021 (IT) 102021000006026

(51) Int. Cl. B07B 11/06; B07B 4/02; B07B 9/02

(52) U.S. Cl. CPC B07B 11/06; B07B 4/02; B07B 9/02

(57) ABSTRACT

A method and an apparatus for recovering down from products padded with it, which comprise the steps of:
cutting (2) adapted to shred the padded product;
subsequent mechanical agitation of the shredded material inside at least one first separation chamber (3, 4), in order to separate at least some of the down from the shredded material;
suction of the down, performed at the first separation chamber (3, 4) and also upstream and/or downstream of the first separation chamber (3, 4);
collection of the aspirated down in at least one container (71-73).

The present invention relates to a method and a corresponding apparatus for recovering down from products padded with down, in particular goose down or duck down, such as for example items of clothing, comforters, pillows and the like.

Currently automated systems are known for recovering down from products padded with them, for the purposes of recycling the various components and in particular in order to reuse the down in new padded products.

However, no effective solution has been found for the problem of extracting down while keeping the quality high, in particular with a low percentage of foreign matter such as fibers or the like, for example less than or equal to 0.5% by weight.

Furthermore, no solution has been found for the problem of extracting down of high quality from heterogeneous padded products, i.e. products made of fabrics and/or yarns that differ from one padded product to another.

The aim of the present invention is to provide a method and an apparatus for recovering down from products padded with it, for the purposes of subsequent recycling, that are capable of improving the prior art in one or more of the abovementioned aspects.

Within this aim, an object of the invention is to improve the separation of the down from the debris of the initial padded product during the recovery method.

Another object is to recover down with a degree of purity that remains high substantially independently of the materials that make up the starting padded products, in particular of the electrostatic behavior of the fabrics and/or of the yarns of such padded products (for example, wool, cotton, polyester) which are typically used in items of clothing padded with down.

Furthermore, an object of the invention is to collect, during the method, down with different degrees of purity separately.

Another object of the invention is to be able to increase, during the recovery method, the degree of purity of the down that has been extracted if it is unsatisfactory.

Furthermore, the present invention sets out to overcome the drawbacks of the background art in a manner that is alternative to any existing solutions.

Another object of the invention is to provide a recovery method and a corresponding apparatus that are highly reliable, easy to implement and low-cost.

This aim and these and other objects which will become more apparent hereinafter are achieved by a method for recovering down from products padded with down, such as items of clothing, comforters, pillows and the like, comprising a step of feeding at least one product padded with down in input to a conveyance line, and characterized in that it comprises the steps of:
cutting adapted to shred said at least one padded product, so as to obtain a shredded material in which said down is mixed with debris of other components of said initial padded product, such as fabric, stitching threads, zip fasteners, buttons and the like, said shredded material being subsequently caused to advance along said conveyance line;
mechanical agitation of said shredded material inside at least one first separation chamber along the conveyance line, said mechanical agitation being adapted to separate at least part of said down from said shredded material;
suction of the separated down, said suction being performed at said first separation chamber and upstream and/or downstream of the first separation chamber;
collection of the aspirated down in at least one down collection container.

The method according to the invention can optionally be provided with one or more of the characteristics of the dependent claims.

The aim and the objects of the invention are likewise achieved by an apparatus for recovering down from padded products, such as items of clothing, comforters, pillows or the like, which comprises an inlet for feeding products padded with down, a conveyance line, and at least one outlet for collecting the down recovered from the padded products fed at the intake, said apparatus being characterized in that it comprises, along said conveyance line:
at least one cutting station adapted to receive from the inlet said padded products, to cut them and to release a shredded material onto said conveyance line as a consequence of said cutting;
downstream of said at least one cutting station, at least one first separation chamber provided with at least one mechanical agitator for said shredded material, said at least one mechanical agitator being adapted to separate at least part of said down from said shredded material;

said apparatus being furthermore characterized in that it comprises:
suction means which are connected to suction ports arranged along said conveyance line, in particular at said first separation chamber and upstream and/or downstream of the first separation chamber, in order to aspirate the down separated from said shredded material and convey it toward at least one collection container.

The apparatus according to the invention can optionally be provided with one or more of the characteristics of the dependent claims.

Further characteristics and advantages of the invention will become more apparent from the description of a preferred, but not exclusive, embodiment of the invention, which is illustrated by way of non-limiting example in the accompanying drawings wherein:

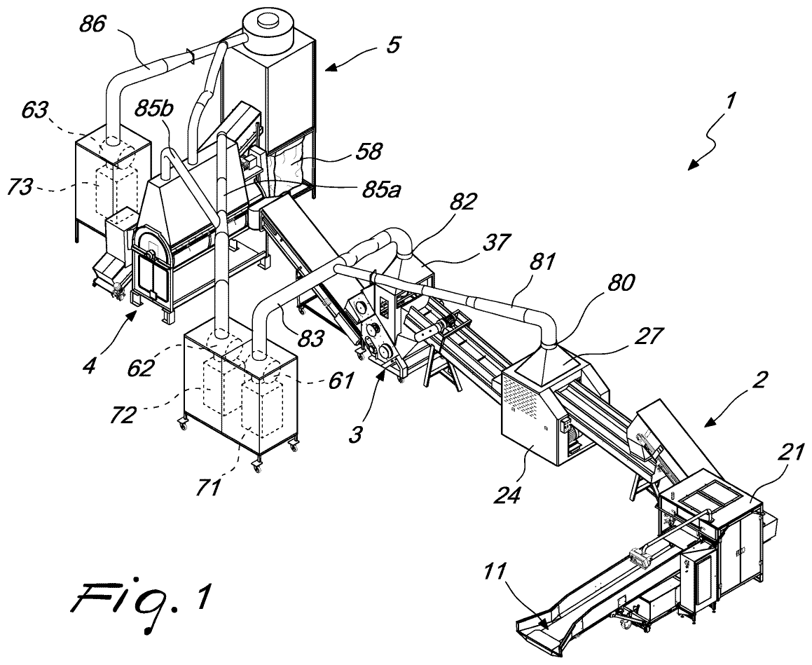

FIG. 1 shows an apparatus according to the invention;

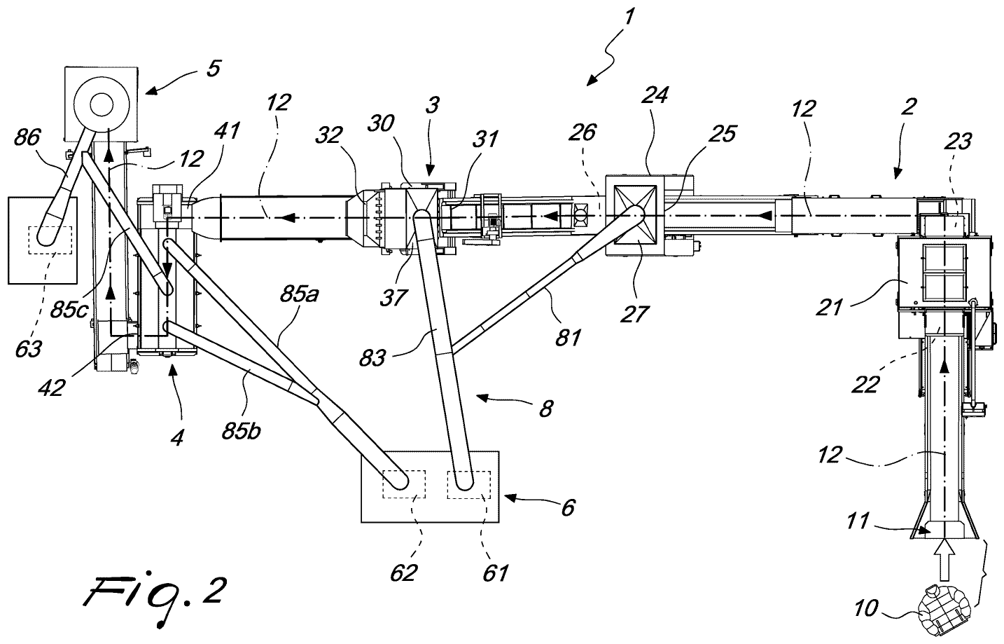

FIG. 2 is a plan view from above of the apparatus of FIG. 1;

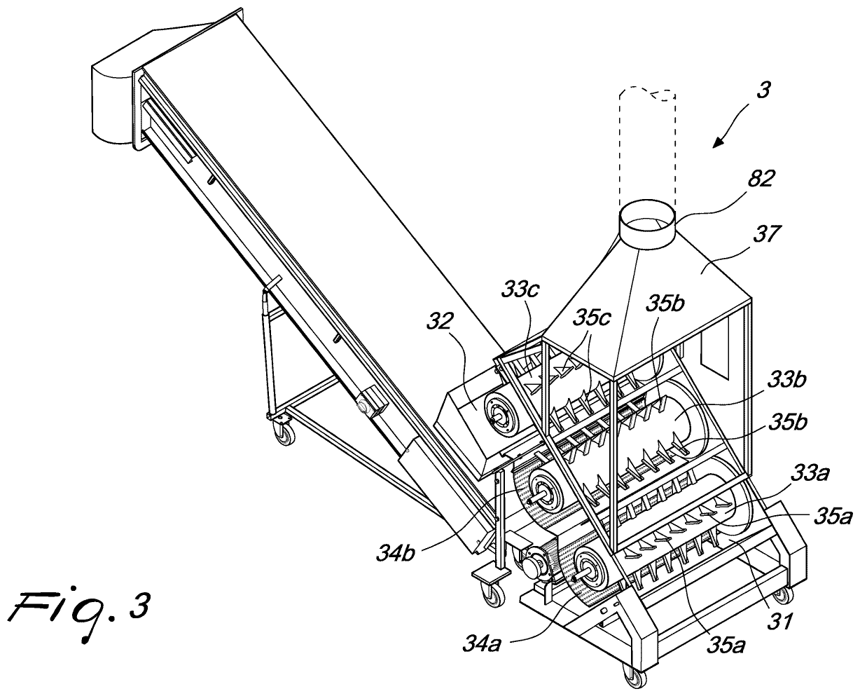

FIG. 3 comprises a partially cutaway view of a first separation chamber of the apparatus of FIG. 1, with an inclined conveyor downstream;

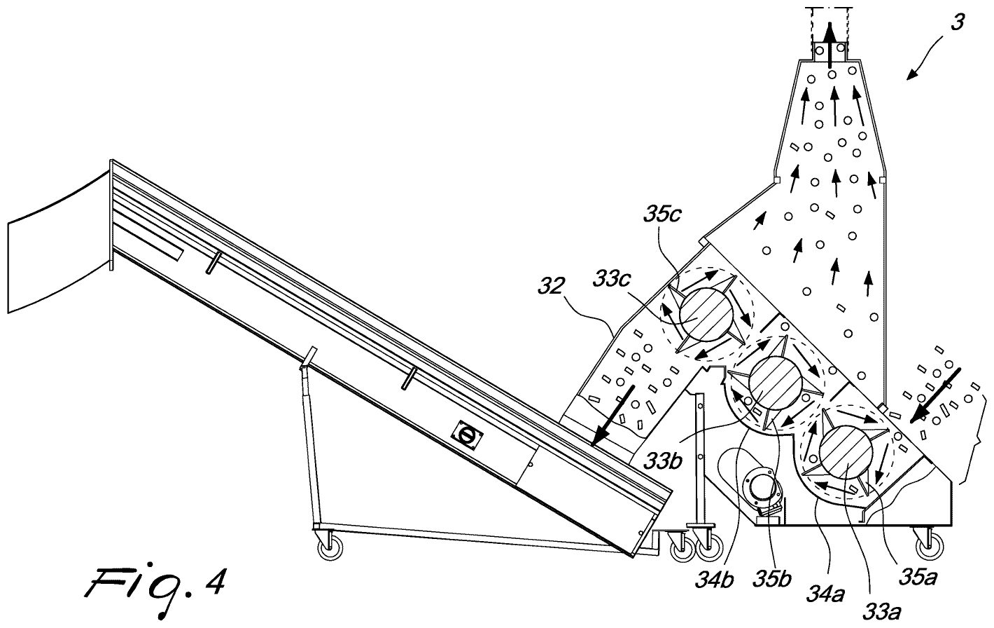

FIG. 4 is a cross-sectional view of the first chamber of the previous figure, with indication of the flows of down and of debris;

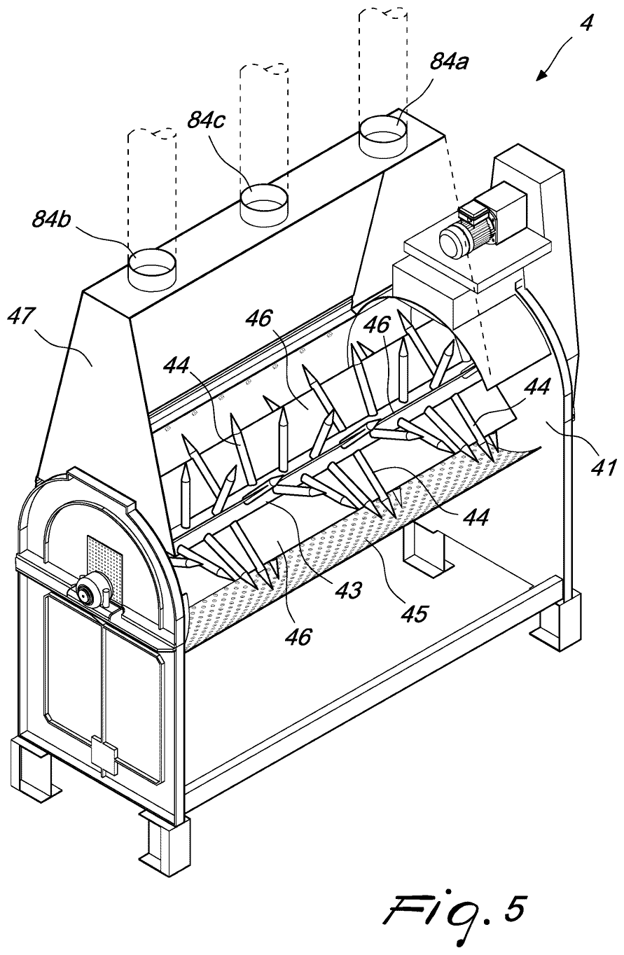

FIG. 5 is a partially cutaway view of a second separation chamber of the apparatus of FIG. 1;

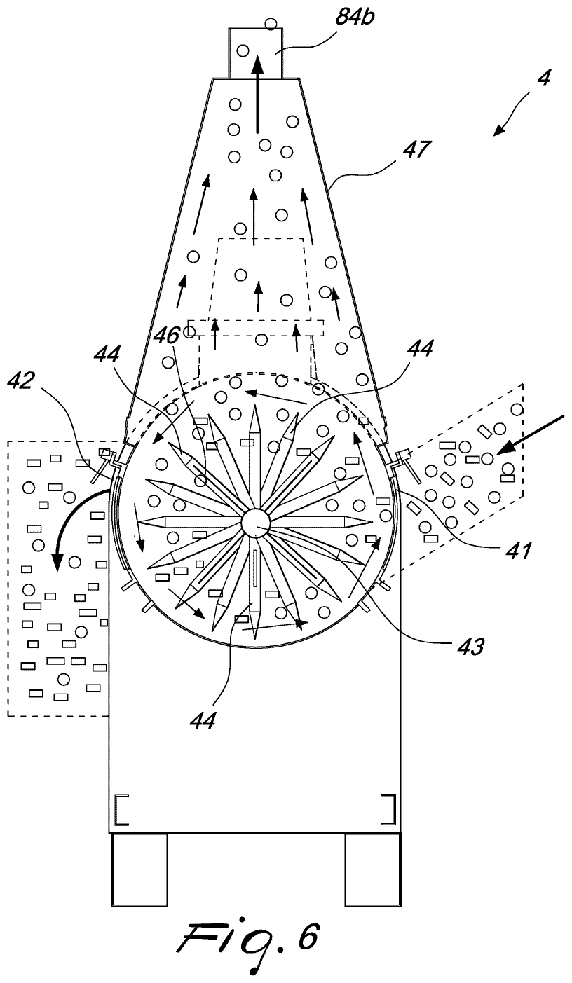

FIG. 6 is a cross-sectional view of the second chamber of the previous figure, with indication of the flows of down and of debris;

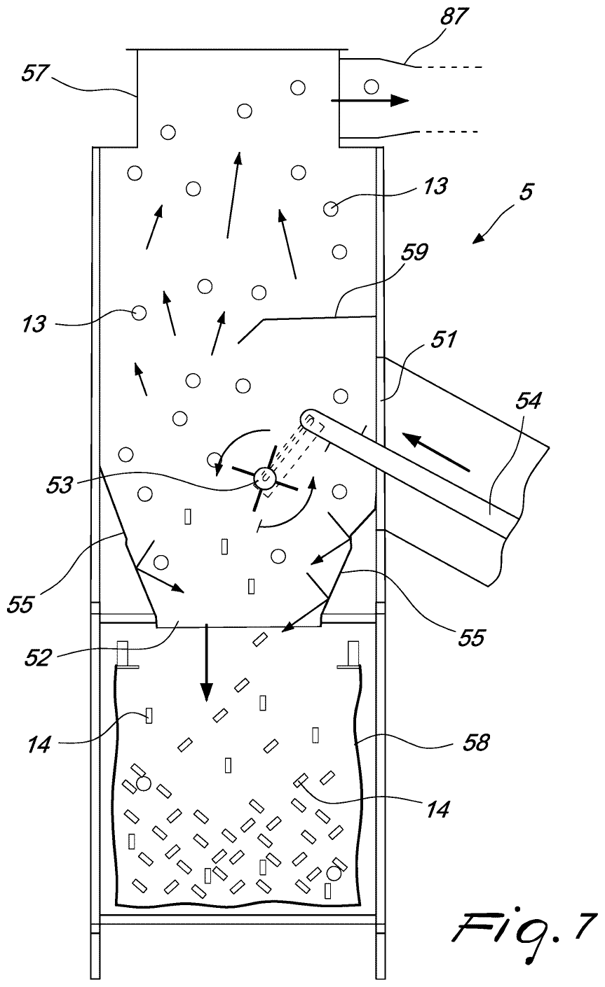

FIG. 7 is a cross-sectional view of a third separation chamber of the apparatus of FIG. 1, with indication of the flows of down and of debris.

With reference to the figures, the apparatus according to the invention, generally designated by the reference numeral 1, is specifically directed at the recovery of down, in particular goose down or duck down, from products 10 padded with down, such as for example items of clothing, comforters, pillows and the like.

Such starting padded products 10, shown schematically in the figures in the form of a jacket, are substantially fabric bags filled with down, in particular goose down or duck down, and are provided with seams and with optional sewing supplies or notions such as zip fasteners, buttons, belts, trim, cords or the like.

The apparatus 1 comprises a conveyance line 12 with an inlet 11 for feeding these padded products 10 and at least one outlet for collecting the down recovered, by virtue of the invention, from the padded products 10 fed into the inlet 11. In the embodiment illustrated, there are three such collection outlets, represented by the mouths of respective down collection containers 71, 72 and 73.

The padded products 10 can be advantageously introduced into the inlet 11 as they are, i.e. without first removing accessories such as zip fasteners and/or buttons. In the preferred embodiments, in fact, the invention is capable of handling padded products even if these types of accessories are relatively heavy.

The conveyance line 12 can be made up of conveyor belts (motorized and preferably enclosed inside a covering in order to prevent the dispersion of the down and to ensure safety) with processing stations 2, 3, 4, 5 of the apparatus 1, which will be better described below, interposed.

One or more conveyor belts can optionally be provided inclined in the advancement direction of the line 12, so as to make the conveyed material rise up to a certain height in order to then let it fall into the processing station immediately downstream, thus possibly contributing to the separation of the components of the material.

The processing stations along the conveyance line 12 comprise at least one cutting station 2, which is adapted to receive the padded products 10 from the inlet 11, to cut them into shreds and to release the material thus shredded onto the conveyance line 12, in particular on a conveyor belt immediately downstream of the cutting station 2 which connects it to a subsequent processing station.

The cutting station 2 preferably comprises a preliminary cutting station 21 and a subsequent rotary cutting station 24.

The preliminary cutting station 21 is preferably of the guillotine type and is adapted to receive in an inlet 22 thereof the padded products 10 (which are fed into the inlet 11 of the apparatus 1) and to reduce them substantially to slivers using at least one guillotine blade, i.e. a substantially vertical movement. The material thus sliced can then be conveyed along the conveyance line 12 between the outlet 23 of the preliminary cutting station 21 and the inlet 25 of the rotary cutting station 24, so as to be able to shred it further and deliver a greater quantity of down components for the subsequent steps at the outlet 26 of the cutting station 2.

The material present at the outlet 26 of the cutting station 2 is herein referred to as “shredded material” and can comprise separated down, clusters of down attached to other residues (typically threads or pieces of fabric) and shreds of other materials and accessories (fabrics, zip fasteners, buttons etc.) possibly mixed with down.

The processing stations along the conveyance line 12 comprise, downstream of the cutting station 2, one or more separation chambers 3 and/or 4, each one provided with at least one mechanical agitator which is adapted to mechanically separate at least part of the down from the incoming shredded material. Each mechanical agitator is advantageously made up of at least one motorized beating roller, with a horizontal rotation axis, i.e. an axis substantially parallel to the floor on which the apparatus 1 rests.

According to an aspect of the invention, the apparatus 1 also comprises suction means 6, which are connected to a plurality of suction ports arranged at at least one separation chamber and also upstream and/or downstream of it along the conveyance line 12, in order to aspirate from above, in several different zones of the line 12 and at determined processing stations, the down separated from the shredded material and to enable such down to be conveyed toward at least one down collection container 71, 72, 73, for example a bin or a sack. Therefore, the suction of the separated down is carried out both at the first separation chamber and at other locations or processing stations along the conveyance line.

The suction means 6 can comprise one or more pneumatic suction machines 61, 62, 63, for example air compressor or fan machines, suction pumps or vacuum pumps, or aspirating fans. Each suction machine 61, 62, 63 can have an intake port connected to the suction ports via means 8 for selective conveyance and an exhaust port connected to the mouth of a down collection container 71, 72 or 73.

The means 8 for selective conveyance are substantially constituted by various tubular suction ducts, conveniently connected in order to convey the down from the various ports to respective collection containers 71-73.

Suction from above is advantageous over introducing an upward-directed air flow, because with suction from above alone, the risk is reduced of also routing debris and down weighed down by contaminants toward the conveyance means 8 and the collection containers 71-73.

The suction machines 61-63 can be arranged inside respective cabinets that also contain the down collection containers 71-73. Alternatively, the suction machines can be arranged along the conduits of the conveyance means 8 or at the suction ports in the processing stations.

In the preferred embodiment, a first separation chamber 3 arranged downstream of the cutting station 2 can comprise a step cleaner 30, which has an inlet 31 that receives the shredded material originating from the cutting station 2, and an outlet 32 for releasing, onto the conveyance line 12, shredded material partially deprived of down via a combination of mechanical agitation and pneumatic suction by way of the suction means 6.

The outlet 32 is preferably provided in tubular form, so as to keep the space between the step cleaner 30 and the conveyor belt downstream of the step cleaner 30 closed.

The step cleaner 30 can be made up of a plurality of beating rollers 33a, 33b, 33c which have a substantially horizontal rotation axis. The beating rollers 33a, 33b, 33c are arranged with their axis substantially perpendicular to the direction of advancement of the shredded material along the conveyance line 12 and at increasing respective heights from the floor, in order to make the shredded material rise up and to progressively separate it from the down that is aspirated. The rotation speed of the beating rollers 33a, 33b, 33c can be comprised between 350 and 400 rpm.

Each beating roller 33a, 33b, 33c is provided with a plurality of vanes 35a, 35b, 35c which protrude from the side wall of the respective roller and are adapted to separate the components of the shredded material and to make them advance, optionally with the aid of concave beating grilles 34a-34b which are arranged below the rotation axes at least of the first rollers 33a-33b of the step cleaner 30 at a radial distance slightly greater than the radial extension of the vanes 35a-35b. The beating grilles 34a-34b can be adapted to allow waste shredded material to pass through, so as to reduce the possibility of the shredded material becoming clogged at the outlet 32.

In the embodiment illustrated, the vanes 35a, 35b, 35c are arranged side by side, at regular intervals, along various mutually equally spaced-apart straight generatrices of the respective beating roller 33a, 33b, 33c.

In alternative embodiments, not shown, the vanes can be arranged in a staggered manner along the side wall of the respective beating roller, or they can be arranged side by side along helical lines.

The step cleaner 30 is closed in an upper region by a first suction hood 37 which is connected to the suction means 6. In particular, the first hood 37 is connected to a first suction machine 61 through a port 82 arranged on the first hood 37 and a first tubular suction conduit 83 of the selective conveyance means 8. The first suction machine 61, for example a pump, can be provided so that its intake port is connected to the first conduit 83 and the exhaust port is connected to a first collection container 71.

The first suction conduit 83 can optionally comprise a first branch 81 that makes it possible to connect the intake port of the first suction machine 61 to another suction port 80 along the conveyance line 12 and preferably upstream of the first separation chamber 3.

In the preferred embodiment, the rotary cutting station 24 is also closed in an upper region by a respective suction hood 27 which is connected to the suction means 6 via a port 80, for example belonging to the abovementioned first branch 81, in order to aspirate part of the down that has advantageously been freed by the rotary cutting and by the preceding preliminary cutting.

This suction of the down at the rotary cutting station 24 can also serve, in addition to recovering down from the shredded material, to reduce the mass of shredded material advancing along the conveyance line 12, in so doing preventing the shredded material from clogging up the line 12.

In an alternative embodiment, not shown in detail, the suction hood of the cutting station 2 can be positioned at the outlet 26 of the rotary cutting station 24, in which the hood closes that outlet 26 in an upper region.

Optionally there can also be suction from above in the preliminary cutting station 21.

Part of the down aspirated at the cutting station 2 and at the step cleaner 30 may be contaminated by residues, in particular threads or scraps of fabric. For this reason, the down collected in the first container 71 after suction can have a lower degree of quality than the target grades and can therefore be handled differently; for example such down can be reintroduced into the apparatus 1.

The shredded material at the outlet 32 of the first separation chamber 3 still contains textile and non-textile residues 14 (fragments of fabric, zip fasteners, buttons etc.) with clusters of down still stuck to them.

Advantageously, downstream of the first separation chamber 3 or in substitution of the latter, along the conveyance line 12 there can be a second separation chamber 4 which is adapted to receive at an inlet 41 thereof, via the conveyance line 12, this shredded material partially deprived of down following the suction carried out in the stations upstream.

The second separation chamber 4 preferably comprises a (second) mechanical agitator of the shredded material, which is advantageously provided with a single motorized beating roller 43 with a horizontal rotation axis and preferably of the type with spikes 44. The spikes 44 are advantageously arranged side-by-side along helical lines about the rotation axis of the beating roller 43, so as to also facilitate an axial advancement of the residual debris 14 from an inlet 41 of the second chamber 4, facing toward one end of the spiked roller 43, to the outlet 42 facing toward the opposite end of the spiked roller 43.

The spiked roller 43 further comprises longitudinal blades 46, each one of which protrudes substantially radially from the rotation axis and extends substantially along the entire length of the roller 43. The longitudinal blades 46, which are angularly equidistant from one another, can be four in number as in the case shown (spaced apart, therefore, by 90°) and they define separation walls between groups of spikes 44, with a height substantially equal to or slightly less than that of the spikes 44.

The spiked roller 43 is substantially a mechanical agitator with a rotation that is preferably much slower than that of the beating rollers 33a-33c of the first separation chamber 3, for example with a rotation speed of approximately one order of magnitude less than that of the beating rollers 33a-33c, which can be comprised for example between 30 and 50 rpm.

The spiked roller 43 advantageously interacts with a lower beating surface 45 (for example a concave grille through which to pass any waste) for separating the down 13.

The spiked roller 43 is further surmounted by a second hood 47 which is coupled to at least one respective upper suction port, which in turn is connected to the suction means 6 and to the conveyance means 8. In particular, the second hood 47, which closes the second chamber 4 from above, can have a plurality of suction ports 84a-84c in an upper region, so that it can optionally be associated with several suction machines 62-63, if a single suction machine 62 has insufficient power to create a partial vacuum in the second separation chamber 4.

In particular, in the preferred embodiment the upper part of the second hood 47 is coupled to two end ports 84a-84b and one central port 84c which is interposed between them. The two end ports 84a-84b are connected with the second suction machine 62, through respective tubular conduits 85a and 85b which converge in a single tube toward the intake port of the second suction machine 62, which passes the down thus aspirated toward a second collection container 72. The central port 84c is instead connected to a third suction machine 63 through an additional tubular conduit 85c and transfers the down thus aspirated toward a third collection container 73.

The second hood 47 can be shaped substantially like a truncated pyramid with a rectangular base and defines, between the ports 84a-84c and the volume occupied by the spiked roller 43, a large closed free space (for example of 1300-1700 liters) in which the down continuously separated from the shredded material is released by means of the spikes 44 and is fed into the second hood 47 through the continuous rotation of the longitudinal blades 46.

The closed free space defined between the walls of the second hood 47 is so large that it would be difficult for it to contain components with a high specific weight, and therefore it facilitates the suction of only the light components, i.e. of the down 13 with a low degree of contamination.

Keeping the ports of the hood 47 sufficiently distant from the roller with spikes 44 (for example, at a distance comprised between 110 cm and 150 cm between the ports 84a-84c and the spikes 44 closest to them) reduces the possibility of aspirating down contaminated with heavy components.

Considering that the residual shredded material at the outlet 42 of the second separation chamber 4, like that at the outlet 32 of the first separation chamber 3, can still have down stuck to debris of other materials, the apparatus 1 can advantageously comprise a third separation chamber 5 in which the shredded material originating from the upstream separation chamber (for example the second chamber 4) is caused to fall by gravity against obstacles, while still keeping a suction from above active in the third chamber 5 in order to collect the down released inside it.

In particular, the third separation chamber 5 can be connected to the second separation chamber 4 by way of a conveyor with cleats 54 that is inclined, in order to bring the residual shredded material from the outlet 42 of the second separation chamber 4 to a higher level into the third separation chamber 5.

The third separation chamber 5 preferably comprises internal obstacle surfaces 55, so that, during the fall, the residual shredded material received at the inlet 51 of the third chamber 5 strikes against such obstacle surfaces 55, thus releasing further down. The obstacle surfaces 55 are substantially chutes, optionally with inclined steps, i.e. they are substantially inclined downward and, in particular, toward a bottom exit 52 for the outflow of the residues 14 of shredded material that fall by gravity. These “heavy” residues can be collected in a bag 58 for their disposal.

The third separation chamber 5 can optionally also comprise a third mechanical agitator 53, for example a motorized cylindrical rotor with a horizontal rotation axis arranged proximately to the inlet 51 of the third chamber so as to intercept the shredded material falling from the inlet 51, in particular from the end of the conveyor 54, and to improve the separation of the down 13 from the debris 14.

Above the inlet 51 of the third separation chamber 5, a protective screen 59 can optionally be arranged which is adapted to prevent the direct aspiration, upward, of down from the shredded material that is still on the conveyor 54.

The third separation chamber 5 is closed in an upper region by a third suction hood 57, with a port 87 connected to the third suction machine 63 by way of a tubular conduit 86, in order to collect the released down 13 in a third collection container 73. The tubular conduit 85c connected to the hood 47 of the second separation chamber 4 can be branched from the tubular conduit 86.

The method according to the invention is evident from the description of the apparatus 1.

In substance, the method entails a step of feeding the padded products 10, which are preferably arranged at the inlet 11 of the conveyance line 12 orienting their lines of stitching so that the latter are not parallel to the direction of guillotining of the station 2, in this way improving the cutting of the stitching threads.

In the cutting step, which as has been seen is preferably composed of a preliminary guillotine cutting and a subsequent rotary cutting, the padded products 10 are reduced to shredded material in which the down 13 is mixed up with debris 14 of other components such as fabrics, stitching threads, zip fasteners, buttons and the like.

Advantageously, a suction is applied from above to the rotary cutting station 24, in order to collect a first part of down released by cutting. This down can be collected in the first container 71, which is destined to contain the most contaminated down that can be recovered from the line 12.

Subsequently one or more steps of separation of the shredded material are carried out, in respective separation chambers 3-4 along the conveyance line 12, wherein the step of separation is performed with the combination of a mechanical agitation of the shredded material with a suction applied above the chamber.

The mechanical agitation is substantially provided by the beating rollers 33a-33c, 43 which rotate continuously about a substantially horizontal axis and optionally by way of impacts when the material falls into a separation chamber 5 at the end of the line, while the suction is obtained with respective hoods 37, 47, 57 which close the respective separation chambers 3, 4, 5 from above.

The hoods 27, 37, 47, 57 are connected, through respective ports and tubular conduits, to the collection containers 71-73. Therefore, during the advancement of the shredded material along the conveyance line 12, the down that is progressively separated from this material, following the cutting and beating operations and the movement operations by suction of the down 13 toward the various different ports arranged along the line 12, will be sorted toward one or more collection containers 71-73, by way of the suction means 6 and the conveyance means 8.

It has surprisingly been found that in the separation chambers further downstream of the conveyance line 12 there is a higher degree of purity of the down extracted than in the stations further upstream and, for this reason, it is preferable to convey the down aspirated from the separation chambers arranged further downstream along the line, such as for example the chambers 4 and 5, to separate containers.

In such case, the down extracted by the stations further upstream (for example by the first chamber 3 and/or by the rotary cutting station 24) can optionally be transferred to the conveyance line 12, for example upstream of the final separation chambers 4 or 5, so as to further reduce the contamination of that down.

The down collected in the containers 71, 72 and/or 73 can undergo subsequent steps of sorting and washing, which are per se conventional, and such down can be recycled by reusing it in a new padded product (for example, an item of clothing).

In practice it has been found that the invention fully achieves the intended aim and objects.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102021000029264 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-19. (canceled)

20. A method for recovering down from products padded with down, such as items of clothing, comforters, pillows and the like, comprising a step of feeding at least one product padded with down in input to a conveyance line, and further comprising the steps of:
cutting adapted to shred said at least one padded product, so as to obtain a shredded material in which said down is mixed with debris of other components of said initial padded product, such as fabric, stitching threads, zip fasteners, buttons and the like, said shredded material being subsequently caused to advance along said conveyance line;
mechanical agitation of said shredded material inside at least one first separation chamber along the conveyance line, said mechanical agitation being adapted to separate at least part of said down from said shredded material;
suction of the separated down, said suction being performed at said first separation chamber and upstream and/or downstream of the first separation chamber;
collection of the aspirated down in at least one down collection container.

21. The method according to claim 20, comprising a second step of mechanical agitation of said shredded material inside at least one second separation chamber, in order to separate down from the shredded material that arrives from said first separation chamber, said suction being applied also to said second separation chamber.

22. The method according to claim 21, wherein the shredded material is caused to fall by gravity into said second separation chamber or into a third separation chamber downstream of said second separation chamber along said conveyance line, so that during the fall said shredded material strikes against obstacle surfaces provided inside said second or third separation chamber, releasing additional down, said suction being applied also to said optional third separation chamber.

23. The method according to claim 20, wherein said down suction is applied also during said cutting step, at a cutting station arranged upstream of said first separation chamber.

24. The method according to claim 21, wherein said down collection step provides for conveying into distinct collection containers the down aspirated upstream of said first separation chamber and the down aspirated in at least said first and/or said second separation chamber.

25. The method according to claim 21, further comprising the step of transferring the content of said at least one first collection container to a point of the conveyance line upstream of said first separation chamber or of said second separation chamber.

26. The method according to claim 20, wherein said cutting step comprises a first, guillotine cutting step followed by a second, rotary cutting step.

27. The method according to claim 21, wherein said mechanical agitation step is performed in said first and/or said second chamber by means of at least one beating roller which has a substantially horizontal rotation axis.

28. An apparatus for recovering down from padded products, such as items of clothing, comforters, pillows or the like, which comprises an inlet for feeding products padded with down, a conveyance line, and at least one outlet for collecting the down recovered from the padded products fed at the inlet, said apparatus further comprising, along said conveyance line:
at least one cutting station adapted to receive from the inlet said padded products, to cut them and to release a shredded material onto said conveyance line as a consequence of said cutting;
downstream of said at least one cutting station, at least one first separation chamber provided with at least one mechanical agitator for said shredded material, said at least one mechanical agitator being adapted to separate at least part of said down from said shredded material;
said apparatus further comprising:
suction means which are connected to suction ports arranged along said conveyance line, at said first separation chamber and upstream and/or downstream of the first separation chamber along the conveyance line, in order to aspirate the down separated from said shredded material and convey it toward at least one collection container.

29. The apparatus according to claim 28, further comprising, downstream of said first separation chamber along said conveyance line, at least one second separation chamber which is adapted to receive, via the conveyance line, the shredded material that arrives from the first separation chamber, said second chamber being connected to at least one respective suction port in order to aspirate, by virtue of said suction means, additional down from said shredded material that arrives from the first separation chamber.

30. The apparatus according to claim 29, wherein said second separation chamber comprises a second mechanical agitator for the shredded material.

31. The apparatus according to claim 30, further comprising, downstream of said second separation chamber, a third separation chamber in which the shredded material that arrives from said second separation chamber is caused to fall by gravity against obstacle surfaces which are internal to said third separation chamber, so that during the fall said shredded material strikes against said obstacle surfaces, releasing additional down, said third separation chamber being connected to said suction means and comprising an exit for the outflow of the residues of said shredded material that have fallen by gravity.

32. The apparatus according to claim 31, wherein said obstacle surfaces are substantially inclined toward said exit, said third separation chamber further comprising at least one third mechanical agitator.

33. The apparatus according to claim 28, wherein said at least one cutting station is connected to said suction means, so as to aspirate any down that has been separated as a consequence of said cutting.

34. The apparatus according to claim 33, wherein said at least one cutting station comprises a preliminary cutting station, preferably of the guillotine type, and a rotary cutting station downstream of said preliminary cutting station, said suction means being connected to said rotary cutting station.

35. The apparatus according to claim 28, further comprising means for selective conveyance of the down aspirated by virtue of the suction means, said conveyance means being configured to convey separately, into respective collection containers, the down aspirated upstream and downstream of a given point of the conveyance line.

36. The apparatus according to claim 30, wherein said mechanical agitators comprise beating rollers which have a substantially horizontal rotation axis.

37. The apparatus according to claim 28, wherein said first separation chamber comprises a step cleaner, which is closed in an upper region by a respective hood which is coupled to at least one respective port connected to said suction means.

38. The apparatus according to claim 28, wherein said first separation chamber or the optional second separation chamber comprises a spiked roller, which has a substantially horizontal rotation axis and is surmounted by a respective hood which is coupled to at least one respective port connected to said suction means, said hood defining, between said at least one respective port and the volume occupied by said spiked roller, a closed free space in which the down separated from said shredded material is released by means of the rotation of said spiked roller, said spiked roller preferably comprising longitudinal blades between which said spikes are interposed.
